(19) United States
(12) Patent Application Publication
(10) Pub. No.: US 2009/0211422 A1
(43) Pub. Date: Aug. 27, 2009

(54) GUILLOTINE CUTTING UNIT

(76) Inventor: Bernd Loibl, Klettgau (DE)

Correspondence Address: BERENATO, WHITE & STAVISH, LLC, 6550 ROCK SPRING DRIVE, SUITE 240, BETHESDA, MD, 20817, US

(21) Appl. No.: 12/388,898

(22) Filed: Feb. 19, 2009

(30) Foreign Application Priority Data
Feb. 21, 2008 (DE) 202008002454.4

(51) Int. Cl. B26D 1/00

(52) U.S. Cl. 83/694

(57) ABSTRACT

A guillotine cutting unit (1) for trimming sheet material (10) has a support plate (2) for supporting the sheet material (10). The support plate has on one side a guillotine cutting device (5) that comprises a pivotably mounted knife arm (6) having a knife edge (8) embodied thereon and a counterknife provided in stationary fashion on the support plate (2). The knife arm (6) comprising a handle (12) for the actuation thereof, wherein the handle is embodied as a knob (12).

The invention relates to a guillotine cutting unit for cutting sheet material, having a support plate for supporting the sheet material, which plate comprises on one side a guillotine cutting device that comprises a pivotably mounted knife arm having a knife edge embodied thereon and a counterknife provided in stationary fashion on the support plate, the knife arm comprising a handle for the actuation thereof.

Cutting units of the aforesaid kind are used in the office sector as tabletop units for adjusting sheet material to a desired dimension. The sheet material can be sheets of paper, photographic paper, cardboard, but also films.

Cutting units of this kind have a support plate, usually rectangular in contour and serving as a base, that forms a horizontally extending support surface for supporting the sheet material that is to be trimmed. Provided on one side of the support plate is a guillotine cutting device that comprises a knife arm having a knife edge embodied on the lower side thereof. Associated with the knife arm is a counterknife, provided in stationary fashion on the support plate, that coacts with the knife edge in the context of the cutting operation. The knife arm is mounted at one end pivotably about a horizontal axis so that it can be swung upward and downward, such that the knife blade wipes past the counterknife.

A guillotine cutting device of this kind may be inferred, for example, from EP 1 475 201 A. In the context of the cutting unit disclosed therein, in addition to the guillotine cutting device a rotary cutting device is also provided on the side located opposite the guillotine cutting device, so that a cutting device optimal for the type of sheet material to be trimmed is always available with no need to procure two cutting units for that purpose.

In the previously known guillotine cutting device, a handle embodied in the manner of an elongated knife grip is provided at the free end of the knife arm so that it can be grasped by one hand. To ensure that the hand does not collide with the support plate in the final phase of the cutting operation, the handle projects outward beyond the support plate, and therefore also beyond the knife edge of the knife arm.

The guillotine cutting units described above are bulky because of the projecting handle, and correspondingly occupy a great deal of space. The risk also exists of becoming caught on the handle. The guillotine cutting unit having such a handle can furthermore be properly operated only from the side at which the handle projects beyond the support plate.

The object underlying the invention is therefore that of configuring a guillotine cutting unit of the kind cited initially in such a way that an actuation of the knife arm can also occur in simple and effective fashion from other, and preferably all, sides. A further object is that of minimizing the space requirement.

This object is achieved according to the present invention in that the handle is embodied as a knob. It has been found, surprisingly, that conformation of the handle as a knob ensures easy operability from all sides of the knife arm, i.e. for example including from the side where the knife arm is pivotably mounted. The knob can be grasped in positively fitting fashion, so that the knife arm can be guided precisely and, if necessary, with a certain lateral pressure for the purpose of contact between the knife edge and counterknife. In addition, a knob has much less of a space requirement than the previously usual handles.

In an embodiment of the invention, provision is made that the knob is mounted on the upper side of the knife arm so that it does not project, or at most projects insignificantly, beyond the free end of the knife arm, and thus also does not protrude beyond the support plate. It is not even necessary in this context for the knob to be arranged in the region of the free end of the knife arm; instead, the possibility certainly exists of attaching it at a distance from the free end of the knife arm in order thereby to promote operability from all sides.

The knob is usefully configured in a mushroom shape. This is to be understood generally as a shape such that it proceeds in slender fashion in the lower region and then ends in a knob- or pommel-shaped enlargement. The enlargement can also have the classic mushroom-cap shape that is curved in spherically convex fashion on the upper side. The enlargement can be flat on the lower side and then transition into a columnar or strut-shaped foot with which the knob is joined to the knife arm.

The knob can have any desired contour. A circular contour is advisable, since handling of the knob is then the same from all sides.

According to a further feature of the invention, provision is made that the knob is removable from the knife arm. It thereby becomes simpler to transport a guillotine cutting unit of this kind, since protruding parts are no longer present once the knob is removed. The knob can be joined to the knife arm, for example, using a clamping or latching device, but also by thread-mounting; the knob itself then constitutes the screw head, and its foot comprises a thread with which the knob is screwed into the knife arm. To prevent loss of the knob, the support plate should comprise an appropriate recess for reception of the knob. The knob can be placed into this recess, and it is useful if the recess comprises a latching device for latch-mounting the received knob in the recess.

The invention is illustrated further, with reference to an exemplifying embodiment, in the drawings, in which:

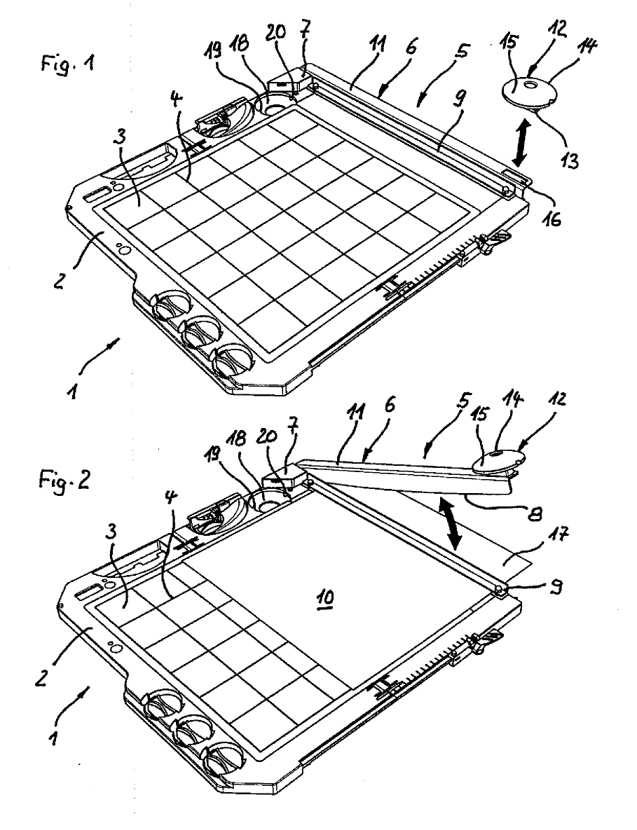

FIG. 1 is an oblique view from above of the guillotine cutting unit according to the present invention; and

FIG. 2 is an oblique view from above of the guillotine cutting unit according to FIG. 1, with the knob installed and the knife arm raised.

Guillotine cutting unit 1 depicted in the Figures comprises a support plate 2 of substantially rectangular contour. Support plate 2 has on the upper side a support surface 3 that is equipped, in the exposed region, with a grid-shaped linear pattern 4.

A guillotine cutting device 5 is arranged on one side of support plate 2. Said device comprises a knife arm 6 that, at the end located remotely in these views, is mounted in a pivot bearing 7 pivotably about a horizontal axis, so that it can be pivoted upward out of the final position depicted in FIG. 1 into the initial position depicted in FIG. 2, or also pivoted downward therefrom back into the final position, this being symbolized by the double arrow depicted in FIG. 2. The lower edge of knife arm 6 is sharpened, and forms a knife edge 8.

Adjacent to knife arm 6, a pressure bar 9 extends above support surface 3 and at a distance therefrom, over almost the entire extension of this side of support plate 2. Pressure bar 9 is held by springs at a distance from support surface 3, so that a sheet of paper 10 can be slid through from support surface 3 under pressure bar 9, as is evident from FIG. 2. Sheet of paper 10 can then be pressed toward support surface 3 and against it by pushing down pressure bar 9, and thus prevented from shifting. Pressure bar 9 covers a counterknife that coacts with knife edge 8 and extends parallel thereto, and is constituted by a sharp edge of cover plate 2 or a separate bar mounted there on support plate 2.

Knife arm 6 has an L-shaped cross section, thus forming an arm flange 11 that is flat on the upper side. This not only imparts torsional stability to knife arm 6, but also offers the possibility of providing, on the upper side of arm flange 11, a knob 12 that is attached in the region of the free end of knife arm 6. Knob 12 is approximately mushroom-shaped, i.e. a mushroom-cap-shaped enlargement 14, which is flat on the lower side and forms a convex dome 15 on the upper side, is shaped onto a cuboidal foot 13.

As is evident from FIG. 1, arm flange 11 comprises a rectangular opening 16, adapted to the conformation of foot 13, into which foot 13 is insertable and by way of which it, and therefore knob 12, can be latch-mounted onto knife arm 6 by displacing knob 12 along knife arm 6 and also detached again in the opposite direction. Because of foot 13, enlargement 14 is at a sufficient distance from knife arm 6 that enlargement 14 can be comfortably grasped, and knife arm 6 thus can be not only lowered from the position shown in FIG. 2 by exerting pressure from above, but also raised out of the final position shown in FIG. 1 by grasping enlargement 14.

If guillotine cutting unit 1 is to be transported, it is a matter of course to remove knob 12 from knife arm 6, since it is merely clamped or latch-mounted onto knife arm 6. An appropriate recess for knob 12 is shaped into support plate 2, into which recess knob 12 can be placed with enlargement 14 at the bottom. Recess 18 has latching projections 19, 20 that prevent knob 12 from falling out after being latched in, but on the other hand also allow knob 12 to be deliberately removed for attachment to knife arm 6.

For the cutting operation, knife arm 6 is raised and sheet of paper 10 (as may be seen in FIG. 2) is slid through beneath pressure bar 9, resulting in an excess length 17 that protrudes beyond support plate 2 and is to be trimmed off sheet of paper 10. Pressure bar 9 is then pushed down manually in order to secure sheet of paper 10 nondisplaceably. Knife arm 6 is then, by actuation of knob 12, moved downward into the final position shown in FIG. 1, in which context knife edge 8 wipes past counterknife 9 and thus ensures a clean cut. After pressure bar 9 is released, the sheet of paper, with excess length 17 removed, can be taken out.

1. A guillotine cutting unit (1) for trimming sheet material (10), having a support plate (2) for supporting the sheet material (10), which plate comprises on one side a guillotine cutting device (5) that comprises a pivotably mounted knife arm (6) having a knife edge (8) embodied thereon and a counterknife provided in stationary fashion on the support plate (2), the knife arm (6) comprising a handle (12) for the actuation thereof,
wherein the handle is embodied as a knob (12).

2. The guillotine cutting unit according to claim 1, wherein the knob (12) is mounted on the upper side of the knife arm (6).

3. The guillotine cutting unit according to claim 1, wherein the knob (12) is arranged at the free end of the knife arm (6).

4. The guillotine cutting unit according to claim 1, wherein the handle is joined to the knife arm (6) via a foot (13), adjacent to which is an enlargement (14).

5. The guillotine cutting unit according to claim 4, wherein the knob is configured in a mushroom shape.

6. The guillotine cutting unit according to claim 1, wherein the knob (12) is curved in spherically convex fashion on the upper side.

7. The guillotine cutting unit according to claim 5, wherein the knob (12) is flat on the lower side.

8. The guillotine cutting unit according to claim 1, wherein the knob (12) has a circular contour.

9. The guillotine cutting unit according to claim 1, wherein the knob (12) is removable from the knife arm (6).

10. The guillotine cutting unit according to claim 9, wherein the knob (12) is clamped and/or latch-mounted and/or thread-mounted onto the knife arm (6).

11. The guillotine cutting unit according to claim 9, wherein the support plate (2) comprises an appropriate recess (18) for reception of the knob (12).

12. The guillotine cutting unit according to claim 11, wherein the recess (18) comprises a latching device (19, 20) for latch-mounting the received knob (12) in the recess (18).
